(19) United States
(12) Patent Application Publication
(10) Pub. No.: US 2008/0097701 A1
(43) Pub. Date: Apr. 24, 2008

(54) SHORT TERM AND LONG TERM FORECASTING SYSTEMS WITH ENHANCED PREDICTION ACCURACY

(75) Inventors: Isztar I. Zawadzki, Montreal (CA); Gyu Won Lee, Sainte-Anne de Bellevue (CA)

Correspondence Address: BERESKIN AND PARR, 40 KING STREET WEST, BOX 401, TORONTO, ON, M5H 3Y2, US

(73) Assignee: MCGILL UNIVERSITY, Montreal (CA)

(21) Appl. No.: 11/470,864

(22) Filed: Sep. 7, 2006

(51) Int. Cl. G01W 1/18; G01W 1/00

(52) U.S. Cl. 702/3

(57) ABSTRACT

The present invention provides a short term weather forecaster for nowcasting using a Numerical Weather Predictor (NWP). The system of the present invention tracks the evolution of differences between NWP and radar based precipitation patterns and adjusts the NWP forecast to account for theses differences. These differences are due to amplitude and phase errors of the NWP, such as model misses, false alarms, intensity errors and position errors. In presuming persistency in time of these errors and in estimating precipitation pattern time evolution due to other weather conditions such as wind motion, the present system corrects the NWP short term predicted patterns to compensate for these errors, thus enhancing nowcasting accuracy.

### FIELD OF THE INVENTION

The invention relates to the field of weather forecasting and more particularly to the field of short term precipitation forecasting (or precipitation nowcasting).

### BACKGROUND OF THE INVENTION

Numerical Weather Predictors (NWPs) are computer systems that predict weather by modeling the atmosphere and using measured weather or atmospheric values as initial input and/or as feedback to predict future weather conditions. NWP's can be very sophisticated and expensive systems that are commonly used for long term precipitation forecasting (more than 12 hours). NWPs comprise generally a data simulator that takes into account a multiple of variables (such as atmospheric heat, atmospheric pressure, wind motion, etc.) to predict weather conditions. NWPs are often able to predict all weather parameters, including temperature, wind, and precipitation (namely rain, sleet or snow). NWP's have limitations in predicting weather due to errors in modeling and a lack of precision or detail in the observations of weather parameters used in the model.

Due to these limitations, NWP's are not considered efficient for short term precipitation forecasting in comparison to short term precipitation forecasting systems. Known precipitation nowcasting systems are very simple systems that use the precipitation pattern persistence principle in order to predict short term future precipitation patterns. Because they are based on the continuation of what has actually taken place in the very recent past, the immediate short term prediction accuracy is very good. While persistence cannot predict new events, such as when rain will begin to fall, or a change in weather patterns when two fronts collide, absent such abrupt changes, persistence-based nowcasting systems are more accurate than NWP's for short term weather prediction.

Doppler weather radar networks can be found today across North America and are able to provide accurate images of spatial distribution of precipitation within large regional areas. The persistence principle involves using observed precipitation patterns from the very recent past (obtained by Doppler radar, satellite images or even weather station observations) to model precipitation pattern motion and project it in the future as a function of wind motion in presuming persistency in time of the observed patterns. Such nowcasting systems are efficient for predicting weather, and most importantly precipitation, for the future few hours with a geographical accuracy corresponding to the observation density.

Even though such precipitation nowcasting systems are widely used by precipitation forecasters because of their simplicity and low cost, they lack the ability to predict changes to weather that can occur in the short term, such as a sudden development of precipitation by way of thundershower or drop in atmospheric temperature, that only NWPs can attempt to predict.

### SUMMARY OF THE INVENTION

It is therefore an object of the present invention to provide a system to enhance accuracy of nowcasting systems, and in some embodiment, precipitation nowcasting systems.

The present invention takes advantage of the complexity of NWP to enhance accuracy of nowcasting systems. It provides a short term weather forecasting system for nowcasting using a Numerical Weather Predictor (NWP). The present nowcasting system tracks the evolution of differences between NWP and radar based precipitation patterns and adjusts the NWP forecast to account for theses differences. These differences are due to amplitude and phase errors of the NWP, such as model misses, false alarms, intensity errors and position errors. In presuming persistency in time of these errors and in estimating precipitation pattern time evolution due to other weather conditions such as wind motion, the present system corrects the NWP short term predicted patterns to compensate for these errors, thus enhancing nowcasting accuracy.

According to one aspect of the invention, there is provided a short term weather forecaster for nowcasting comprising a numerical weather predictor receiving measured weather variables and generating, as a function of a first mathematical model and of the measured weather variables, short term and long term predicted weather variables, an error modeling unit receiving the predicted variables and measured weather variable corresponding to the predicted weather variables, and generates a time function error model based on short term past predicted and measured weather variables, and a short term error correction unit, where the unit receives the short term predicted weather variables and the time function error model, corrects the short term weather variables as a function of the time function error model and outputs corrected short term predicted weather variables associated with the short term weather predicted variables.

In some embodiments, the invention is applied to precipitation, instead of other weather variables such as temperature, pressure, wind, etc. The measured weather variables and the predicted weather variables can be precipitation variables representing precipitation maps, and the error model can correct errors in the precipitation maps. The measured weather variables can in some embodiments include wind motion variables, while the error modeling unit identifies a miss, and the error correction unit generates a prediction of the miss using persistence of the measured wind motion and precipitation variables. Wind motion variables may be estimated using a variational echo tracker.

In some embodiments, the error correction unit generates a persistence prediction of short term weather based on persistence of the measured weather variables and combines the persistence prediction with the short term weather variables corrected as a function of the time function error model to output the corrected short term predicted weather variables associated with the short term weather predicted variables.

Short term forecasting is often understood to mean less than twelve hours, and reasonable accuracy of short term forecasting may be limited to about six hours in certain climate conditions.

In some embodiment, the short term weather forecaster for nowcasting is for use with a numerical weather predictor receiving measured weather variables and generating, as a function of a first mathematical model and of the measured weather variables, short term and long term predicted weather variables. As above, the short term weather forecaster may include an error modeling unit receiving the predicted variables and measured weather variable corresponding to the predicted weather variables, and generates a time function error model based on short term past predicted and measured weather variables, and a short term error correction unit, where the unit receives the short term predicted weather variables and the time function error model, corrects the short term weather variables as a function of the time function error model and outputs corrected short term predicted weather variables associated with the short term weather predicted variables.

In other embodiments, a numerical weather predictor (NWP) for forecasting comprises a numerical weather prediction module receiving measured weather variables and generating, as a function of a first mathematical model and of the measured weather variables, short term and long term predicted weather variables, an error modeling unit receiving the short term predicted weather variables and corresponding measured weather variables, and generates an error model based on short term past predicted and measured weather variables, and the numerical weather prediction module uses the error model to estimate adjusted initial conditions of the first mathematical model. The numerical prediction module uses the error model to generate short term corrected predicted weather variables, the corrected predicted weather variables being used to estimate the adjusted initial conditions of the first mathematical model.

In further embodiments, the invention is embodied as a computer program product. This product comprises a data recording medium, such as a CD-ROM, electronic memory device, magnetic storage drive, etc. having recorded thereon executable computer program code that when loaded into a suitable computer and executed provides a short term weather forecaster according to any one of the embodiments described or defined in this specification.

### BRIEF DESCRIPTION OF THE DRAWINGS

FIG. 1 shows a block diagram of a short term weather forecaster for nowcasting using a Numerical Weather Predictor (NWP);

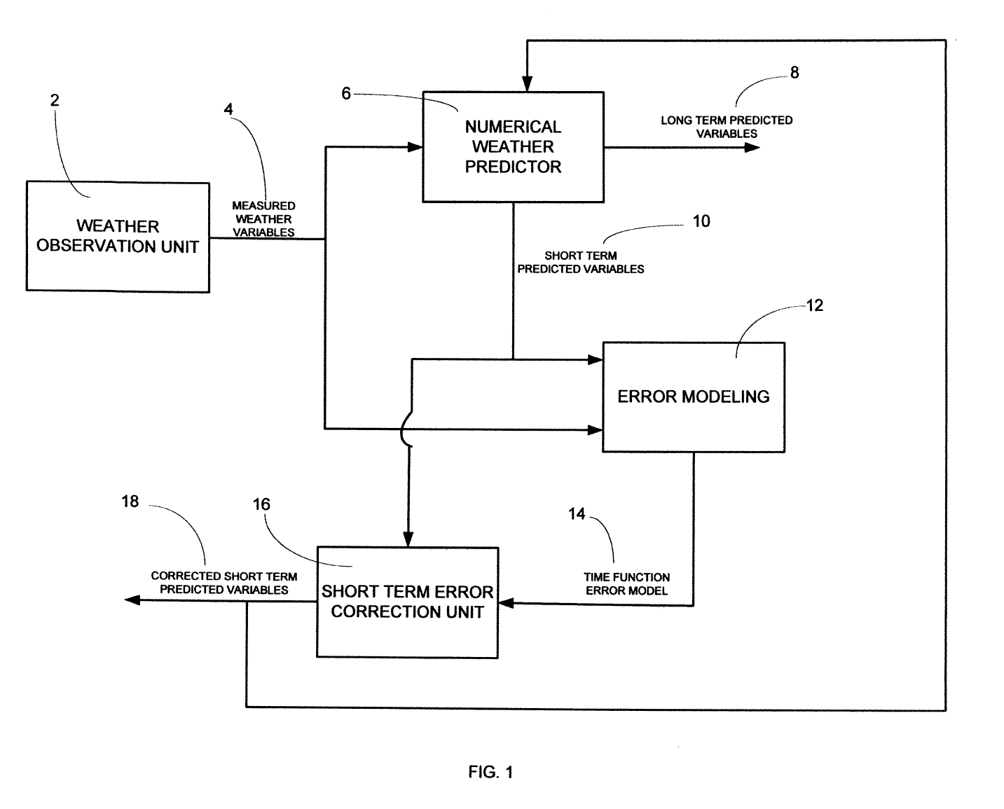

FIG. 2 illustrates an amplitude error of the NWP due to a model miss;

FIG. 3 illustrates an amplitude error of the NWP due to a false alarm;

FIG. 4 illustrates an amplitude error of the NWP due to an intensity error;

FIG. 5 illustrates a phase error (position error) of the NWP;

FIG. 6 illustrates the cumulative error effect due to model misses, false alarms, intensity errors and phase errors;

FIG. 7 illustrates generation of the extrapolation function (tao) using the error distance between observed and measured precipitation patterns;

FIG. 8 illustrates use of the extrapolation function (tao) to generate a short term forecasting precipitation pattern and compare it to the measured pattern;

FIG. 9 is a Model-Radar correlation curve illustrating enhancement of accuracy between a traditional nowcasting system and the nowcasting system as provided by the present invention.

### DETAILED DESCRIPTION OF THE INVENTION

The functionality of the developed weather nowcasting system could be detailed as follows. A Weather Observation Unit 2, generally connected to a weather radar, measures weather conditions and transmits Measured Weather Variables 4 to a Numerical Weather Predictor (NWP) 6. The Measured Weather Variables 4 comprise precipitation variables, wind motion variables and any other measured variables related to weather conditions. The NWP 6 receives the Measured Weather Variables 4, processes them according to a precipitation-forecasting algorithm and outputs Long Term Predicted Weather Variables 8 and Short Term Predicted Weather Variables 10. The Short Term Predicted Weather Variables 10 and the corresponding Measured Weather Variables 4 are transmitted to an Error Modeling Unit 12. In one embodiment of the invention, the Short Term Predicted Weather Variables 10 include the present state of precipitation (at t₀) and the state of precipitation just before (at t₋₁) and the Error Modeling Unit 12 measures the error “distance” between predicted precipitation and measured precipitation over the short term past.

By error distance, it is understood to mean an error function or model describing the spatial or morphological and/or temporal error or difference in the spatial or spatio-temporal map of weather variables. The error model can be a correction in space or distance only (namely a spatial shift of a region within the map corresponding to an event), an error in time only, an account of false event prediction only (such as an incorrect forecast of rain from a group of clouds, while actual measurements do not show rain), an account of a failure or a miss to predict an event only (such as an incorrect forecast of no rain from a group of clouds, while actual measurements show rain), or an error in intensity of a prediction only (such as a level of temperature, wind or precipitation within a local area or event). Of course, the error model can combine one or more of such elements. In the case of a false event prediction, the error function or model strives to remove or greatly attenuate the event from the short term predicted values from the NWP. In the case of a miss, the event is predicted from the persistence of the observed past values without using the NWP's predicted values, and the NWP's past values are used merely to identify the miss.

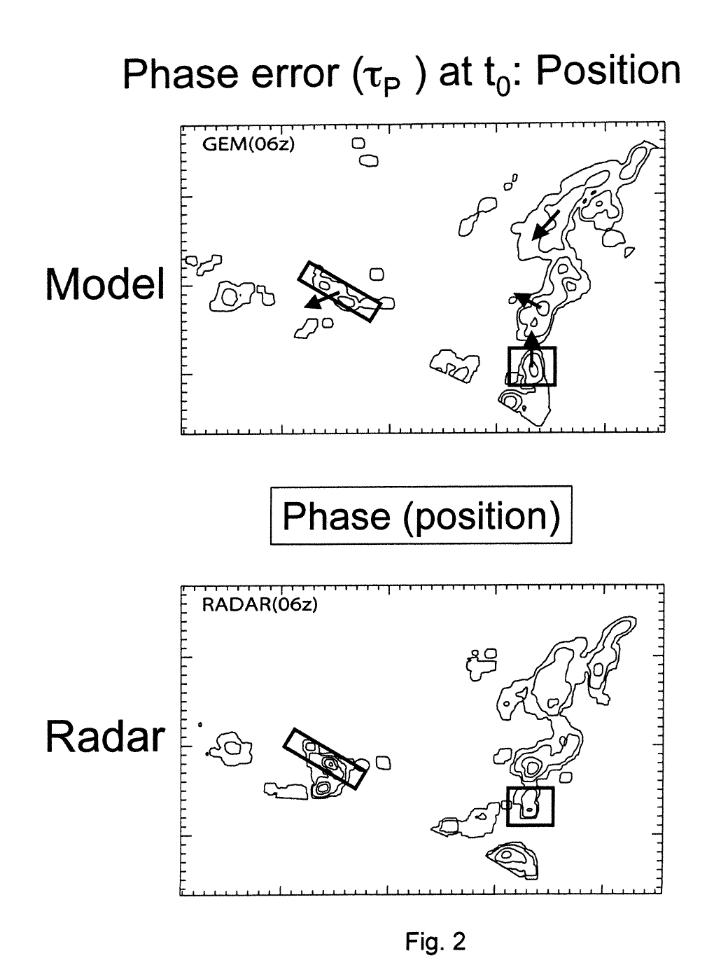

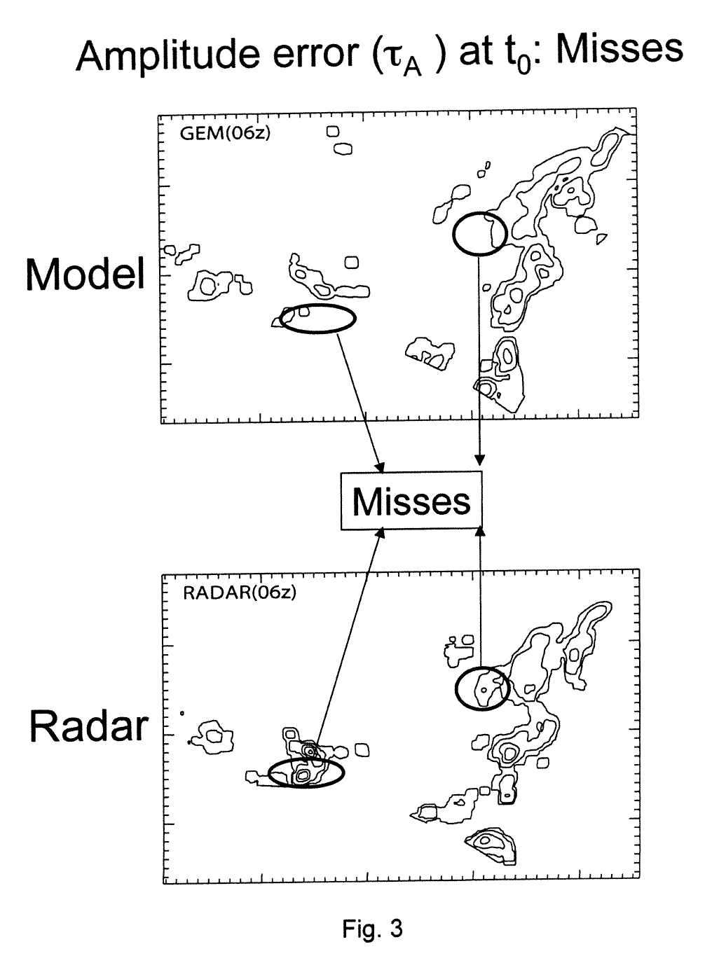

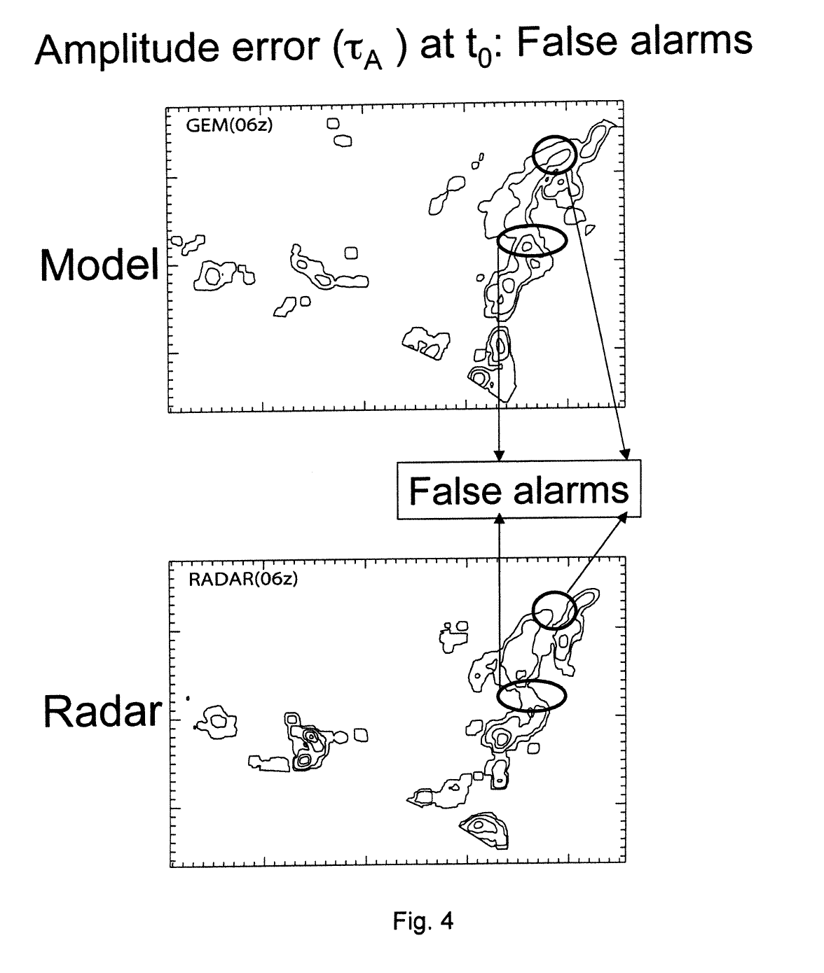

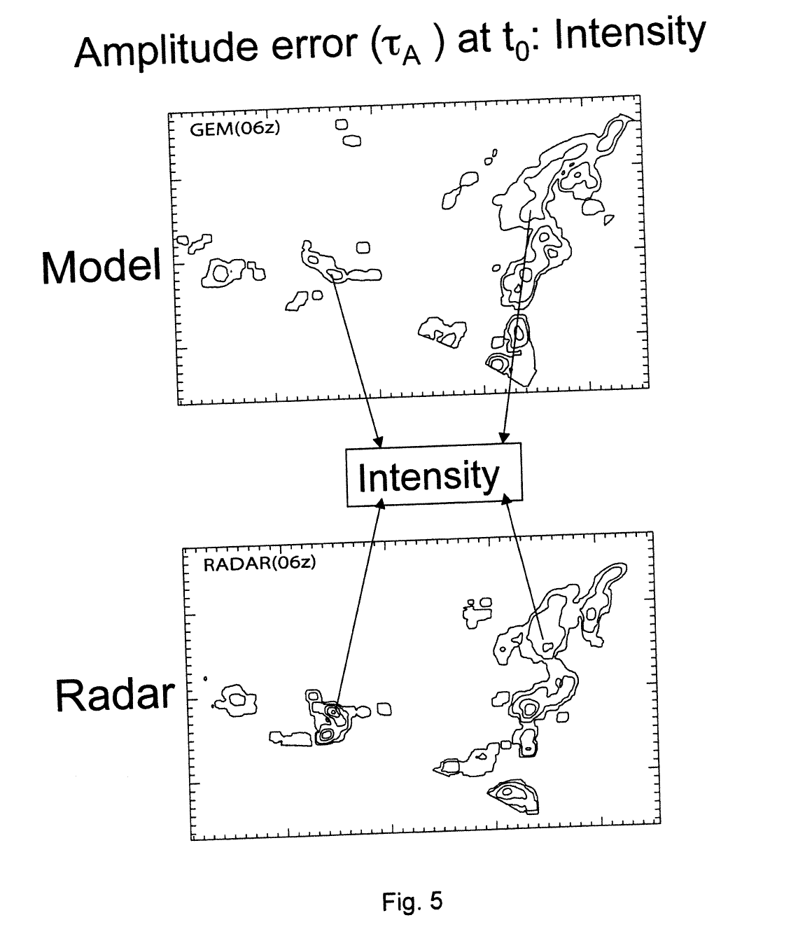

As shown in FIG. 2, there is a model miss when the NWP 6 fails to predict, for a specific spot in space and for a specific time, an existing state of precipitation measured by a Radar. On the contrary, there is a false alarm when the NWP 6 predicts, for a specific spot in space and for a specific time, a non-existing state of precipitation according to the Radar (see FIG. 3). There is an intensity error when the predicted intensity of precipitation is different from the measured one (see FIG. 4). As regards the position error, the latter arises when the NWP 6 predicts a state of precipitation in a certain spot in space different from the real spot where the given state of precipitation arose according to the Radar (see FIG. 5).

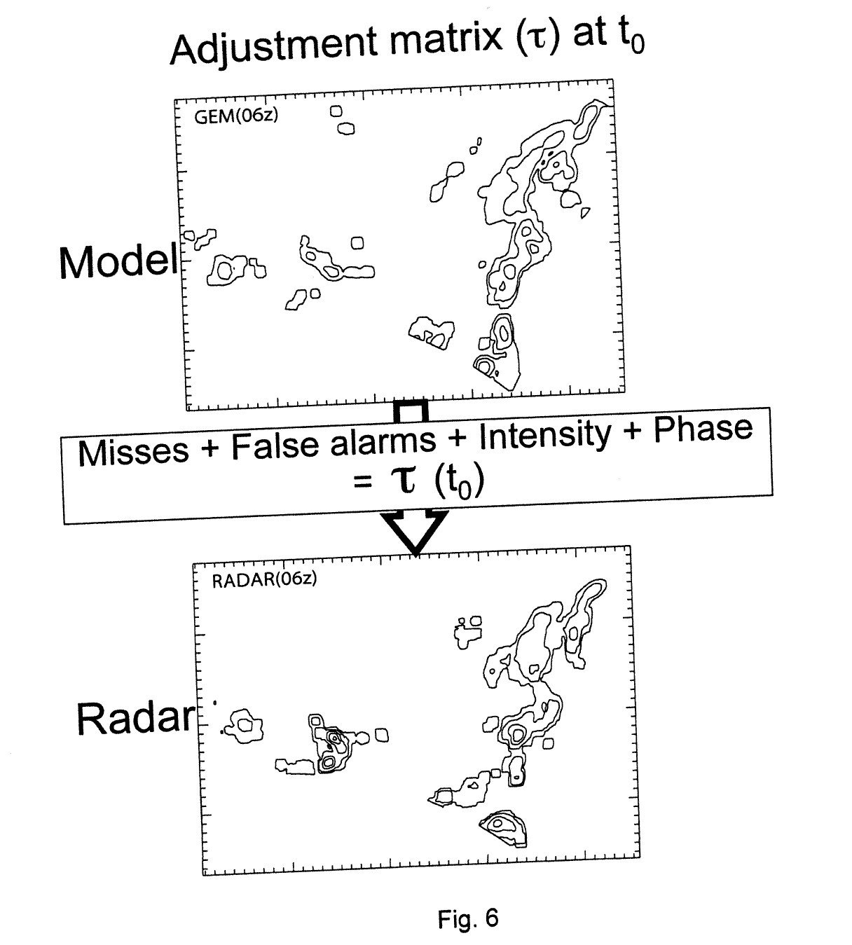

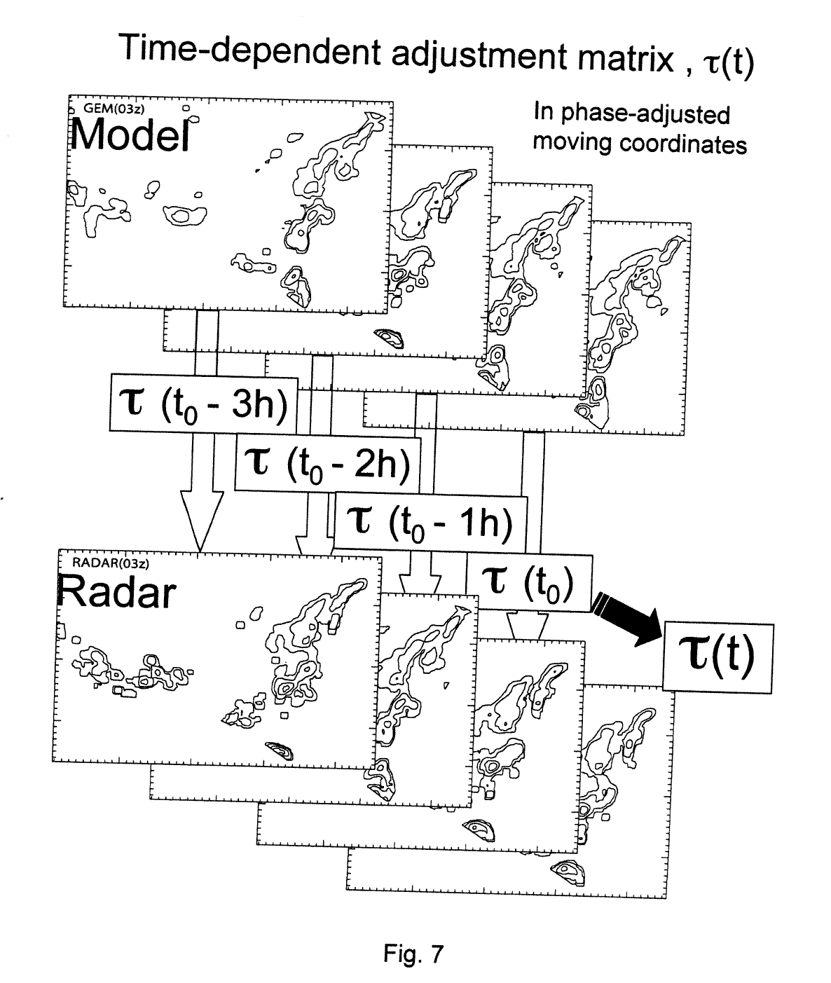

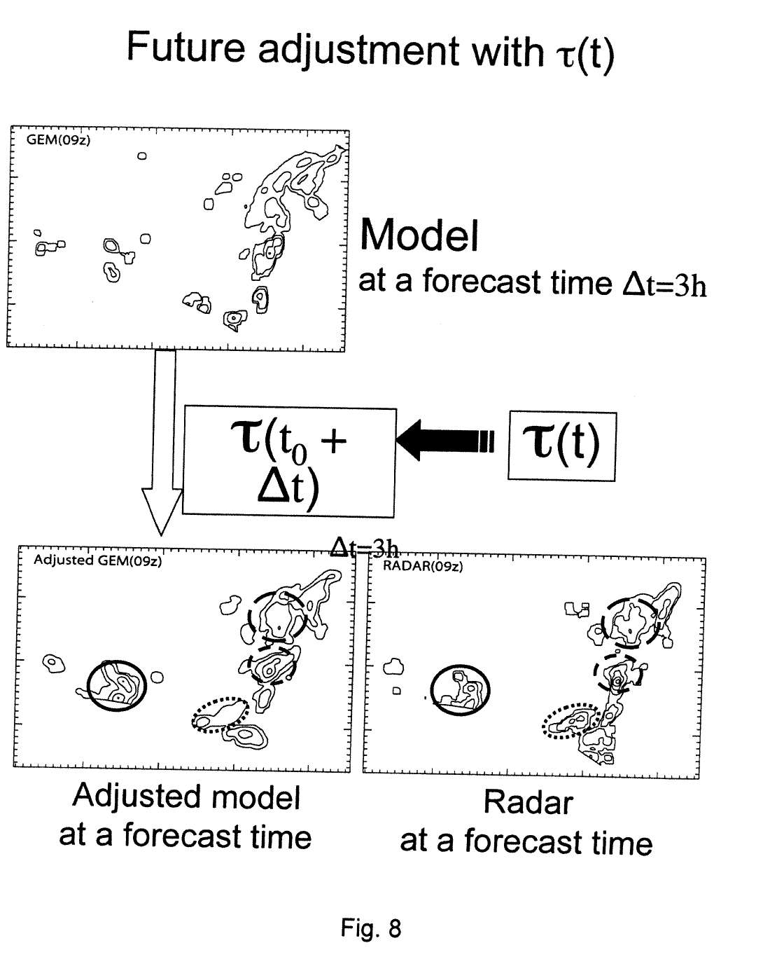

After measuring the error distance, the Error Modeling Unit 12 generates and updates a Time Function Error Model 14 (see FIG. 6 to 8). The Time Function Error Model 14 is then transmitted to a Short Term Error Correction Unit 16 that corrects, according to the Error Model 14, the Short Term Predicted Variables 10 transmitted by the NWP 6.

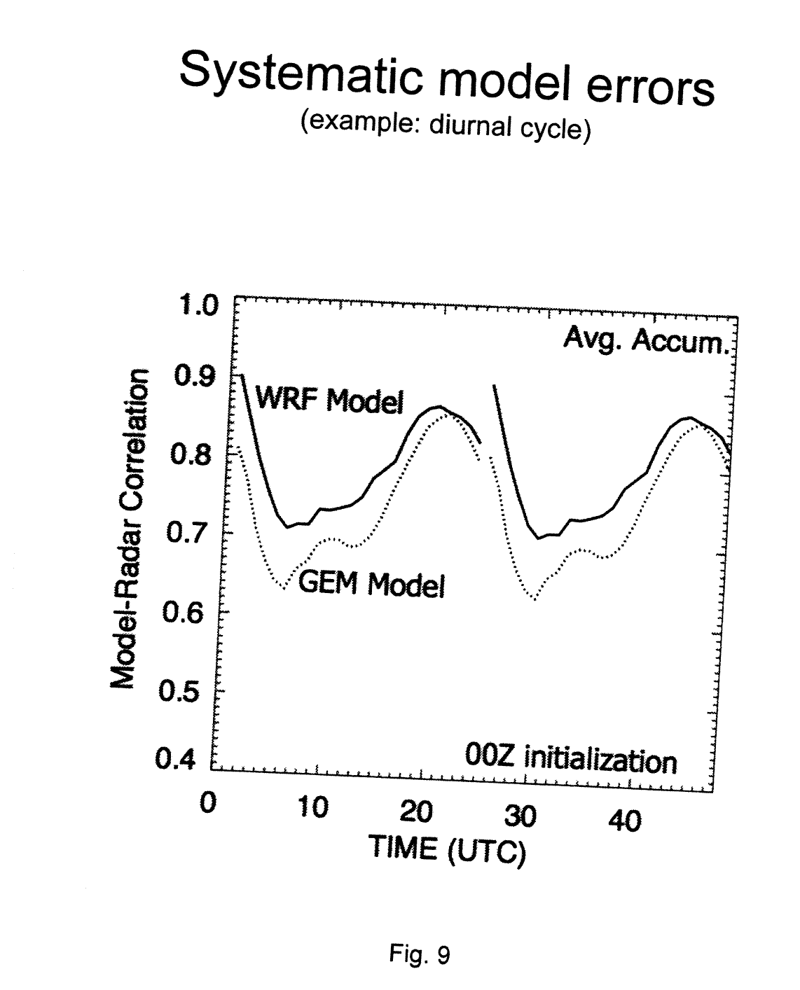

The Time Function Error Model 14 is preferably an extrapolation function that extrapolates error occurrences in the future time, based on occurred errors and on measured weather variables such as precipitation motion direction and precipitation motion speed. The Short Term Error Correction Unit 16 outputs Corrected Short Term Predicted Variables 18 associated with the received Short Term Predicted Variables 10. FIG. 9 illustrates an enhancement of accuracy of precipitation nowcasting (short term prediction) by using the above-illustrated system.

It is also possible to enhance the accuracy of precipitation forecasting (long term prediction) by using the Corrected Short Term Predicted Variables 18 to set up the initial conditions of the mathematical model of the NWP 6.

The present invention is based on correction of errors of NWP (numerical weather prediction) outputs. The correction of model outputs is performed with two components: phase and amplitude (or intensity) errors (τ_{P} and τ_{A}). These errors and their tendencies are determined by comparison with current and past observations for each geographical pixel determined by the resolution of the NWP. Then, during a certain forecast time model outputs are modified by correcting the time-dependent errors. For precipitation we apply various corrections:

### 1. Correction of Constant Phase Errors (CPE), τ_{P}(x,t₀):

Establish a homomorphism that is, a pixel-to-pixel correspondence between model precipitation output and radar patterns. For this minimize the following cost function

$$J = {J}_{ψ} + {J}_{s}$$

$$where$$

$${J}_{ψ} = \int {\int }_{Ω}^{ } {a [ {ψ}_{R} ( x + α , y + β , t ) - {ψ}_{M} ( x , y , t ) ]}^{2} d x d y$$

$${J}_{s} = b \int {\int }_{Ω}^{ } [ ( \frac{{\partial }^{2} α}{\partial {x}^{2}} ) + ( \frac{{\partial }^{2} α}{\partial {y}^{2}} ) + ( \frac{{\partial }^{2} β}{\partial {x}^{2}} ) + ( \frac{{\partial }^{2} β}{\partial {y}^{2}} ) + ( \frac{{\partial }^{2} α}{\partial x \partial y} ) + ( \frac{{\partial }^{2} β}{\partial x \partial y} ) ] d x d y$$

Here ψ_{R} and ψ_{M} are the precipitation intensity or accumulation values, as a function of space at time t=t₀ of the initiation of the nowcast, measured by radar and given by the NWP model output, respectively; Ω is the domain over which ARMOR is applied. α and β are the control variables of the minimization problem. The solution of the minimization gives, for each pixel, a vector

$$( \begin{matrix}α \\ β\end{matrix} ) .$$

The ensemble of these vectors gives the x and y components of initial spatial phase errors within a domain Ω, that is, the matrix of errors τ_{P}(x,t₀). This matrix represents the full two-dimensional field of vectors necessary to produce the displacements and deformations of the NWP model output to match the observations at t₀.

The minimization of the cost function is performed by a variational method using a conjugate-gradient method (although other methods are equally possible). In this manner a field of vectors (τ_{P}) is determined over the domain, one vector per each resolution pixel of the NWP precipitation output. The parameters a, b are adjustable weights, with a representing the uncertainty in radar measurements and b chosen as an empirical compromise between eliminating noise in the retrieved spatial phase error vectors and the spatial variability in the phase error vectors. To account for time phase errors the cost function is modified to

$${J}_{ψ} = \int \int {\int }_{Ω}^{ } {a [ {ψ}_{R} ( x + α , y + β , t + γ ) - {ψ}_{M} ( x , y , t ) ]}^{2} d x d y$$

$${J}_{s} = b \int \int {\int }_{Ω}^{ } [ ( \frac{{\partial }^{2} α}{\partial {x}^{2}} ) + ( \frac{{\partial }^{2} α}{\partial {y}^{2}} ) + ( \frac{{\partial }^{2} β}{\partial {x}^{2}} ) + ( \frac{{\partial }^{2} β}{\partial {y}^{2}} ) + 2 ( \frac{{\partial }^{2} α}{\partial x \partial y} ) + 2 ( \frac{{\partial }^{2} β}{\partial x \partial y} ) ] d x d y d t + b \int \int {\int }_{Ω}^{ } [ ( \frac{{\partial }^{2} γ}{\partial {t}^{2}} ) + ( \frac{{\partial }^{2} γ}{\partial {x}^{2}} ) + ( \frac{{\partial }^{2} γ}{\partial {y}^{2}} ) + ( \frac{{\partial }^{2} α}{\partial {t}^{2}} ) + ( \frac{{\partial }^{2} β}{\partial {t}^{2}} ) ] d x d y d t + b \int \int {\int }_{Ω}^{ } 2 [ ( \frac{{\partial }^{2} γ}{\partial x \partial y} ) + ( \frac{{\partial }^{2} γ}{\partial t \partial y} ) + ( \frac{{\partial }^{2} γ}{\partial x \partial t} ) + ( \frac{{\partial }^{2} α}{\partial t \partial y} ) + ( \frac{{\partial }^{2} α}{\partial t \partial y} ) + ( \frac{{\partial }^{2} β}{\partial t \partial y} ) + ( \frac{{\partial }^{2} β}{\partial t \partial y} ) ] d x d y d t$$

The minimization of the above leads to a field of vectors

$$( \begin{matrix}α \\ β \\ γ\end{matrix} )$$

in the three-dimensional space giving the phase error (τ_{P}) for each pixel are the displacement in space and time necessary to establish the above pixel-to-pixel correspondence.

Model outputs at a certain forecast time tᵢ are corrected by backward advection with derived three-dimensional initial phase error τ_{P}(x,t₀). A cubic interpolation is done to place a corrected model value at a grid point. Since the correction of model errors is done with τ_{P}(x,t₀), the growth and decay predicted by the NWP model is retained. However, τ_{P}(x,t₀) does not take into account the time tendency of the phase errors. Thus, the following step is added to the procedure:

### 2. Correction of Lagrangian Time-Dependent Phase Errors (LTPE), τ_{P}(x,t)

Consider now the time tendency of the phase error along the movement of the precipitation pattern. First, determine the motion pattern, defined by the vector

$$u = ( \begin{matrix}u \\ v\end{matrix} ) ,$$

of radar derived precipitation by minimizing the difference between radar precipitation patterns at a times t₀ and t₀−Δt. For this minimize the following cost function:

$${J}_{ψ} = \int {\int }_{Ω}^{ } {a [ {ψ}_{R} ( x , y , t ) - {ψ}_{R} ( x - u Δ t , y - v Δ t , t - Δ t ) ]}^{2} d x d y$$

$${J}_{s} = b \int {\int }_{Ω}^{ } [ ( \frac{{\partial }^{2} u}{\partial {x}^{2}} ) + ( \frac{{\partial }^{2} u}{\partial {y}^{2}} ) + ( \frac{{\partial }^{2} v}{\partial {x}^{2}} ) + ( \frac{{\partial }^{2} v}{\partial {y}^{2}} ) + ( \frac{{\partial }^{2} u}{\partial x \partial y} ) + ( \frac{{\partial }^{2} v}{\partial x \partial y} ) ] d x d y$$

Here, Δt is the time lag over which pattern motion is determined.

The total time period over which motion of precipitation from radar and from NWP model outputs are to be compared is nΔt and n patterns of precipitation motion are derived for the period between t=t₀ and t=t₀−nΔt. A more detailed description of the procedure to derive the motion pattern is given in Germann, U. and I. Zawadzki, 2002: “Scale dependence of predictability of precipitation from continental radar images. Part I: Description of methodology”, Monthly Weather Review, 130, pp 2859-2873.

The same procedure is then repeated for ψ_{M} for a period between t=t₀−nΔt and t=tᵢ (where tᵢ is the forecast time) to obtain the motion patterns of the NWP model precipitation outputs for the past nΔt and for the future up to the forecast time tᵢ.

Then, two corresponding pixels of the radar pattern and NWP output, established by τ_{P}(x,t₀), are backward advected from t₀ with their own motion vectors. Now, the time-dependent phase errors ψ_{P}(x,t) are derived by comparing positions of corresponding advected pixels at t=t₀−Δt, . . . , t₀−nΔt. At the forecast time, tᵢ, the NWP model forecast fields ψ_{M} at t=tᵢ are corrected with ψ_{P}(x,tᵢ) with each pixel of ψ_{M}(x, y, tᵢ) tracked from its position at t₀ by following the motion of the NWP model precipitation patterns.

### 3. Correction of Lagrangian Intensity Errors (LIE), τ_{A}(x,t).

After adjustment of the phase errors, whatever residual differences remain between the intensity of precipitation given by radar and model are classified as NWP false alarms, misses, and amplitude errors. False alarms are pixels for which NWP predicts precipitation but none is observed above the detectable threshold; misses are pixels for which NWP fails to predict the observed precipitation; amplitude errors τ_{A} are the differences in intensity of precipitation for each pixel for which NWP predicts precipitation and precipitation is observed at that pixel.

τ_{A}(x,t)=ψ_{R}[x+τₚ(t),t]−ψ_{M}[x,t]

where t=t₀, . . . , t₀−nΔt.

False alarms are replaced with the value of no rain. Similar to the phase correction, we correct ψ_{M}(x,y,tᵢ) with the time dependent τ_{A}(x,t). Again, all corrections are applied following the motion of NWP precipitation patterns.

The corrected ψ_{M}(x,y,tᵢ) maintains the growth and decay as well as the motion of precipitation patterns at a future time that rely on the performance of the NWP models.

It will be appreciated that a model of the motion pattern of short-term past observed weather can be used to perform short-term prediction of weather. This technique is presently implemented for precipitation nowcasting at McGill University in a tool called MAPLE. In a further embodiment of the invention, such short-term prediction or nowcasting technique can be combined with the short-term prediction obtained by using the error model and the NWP's short-term predicted values as described hereinabove to yield a balanced or weighted combination of the two nowcasting techniques that may be more reliable under some conditions.

What is claimed is:

1. A short term weather forecaster for nowcasting comprising:
a numerical weather predictor receiving measured weather variables and generating, as a function of a first mathematical model and of said measured weather variables, short term and long term predicted weather variables;
an error modeling unit receiving said predicted variables and measured weather variable corresponding to said predicted weather variables, and generates a time function error model based on short term past predicted and measured weather variables;
a short term error correction unit, where said unit receives said short term predicted weather variables and said time function error model, corrects said short term weather variables as a function of said time function error model and outputs corrected short term predicted weather variables associated with said short term weather predicted variables.

2. A short term weather forecaster as claimed in claim 1, wherein said measured weather variables and said predicted weather variables comprise precipitation variables representing precipitation maps, and said error model corrects errors in said precipitation maps.

3. A short term weather forecaster as claimed in claim 2, wherein said measured weather variables further comprising wind motion variables, said error modeling unit identifies a miss, and said error correction unit generates a prediction of said miss using persistence of said measured wind motion and precipitation variables.

4. A short term weather forecaster as claimed in claim 3, wherein said wind motion variables are estimated using a variational echo tracker.

5. A short term weather forecaster as claimed in claim 1, wherein said error modeling unit identifies a miss, and said error correction unit generates a prediction of said miss using persistence of said measured variables.

6. A short term weather forecaster as claimed in claim 1, wherein said error modeling unit identifies a false prediction of an event, said error correction unit removing or greatly attenuating said falsely predicted event from said short term predicted weather variables.

7. A short term weather forecaster as claimed in claim 2, wherein said error modeling unit identifies a false prediction of an event, said error correction unit removing or greatly attenuating said falsely predicted event from said short term predicted weather variables.

8. A short term weather forecaster as claimed in claim 1, wherein said time function error model accounts for intensity errors and spatio-temporal position errors.

9. A short term weather forecaster as claimed in claim 2, wherein said time function error model accounts for intensity errors and spatio-temporal position errors.

10. A short term weather forecaster as claimed in claim 1, wherein said error correction unit generates a persistence prediction of short term weather based on persistence of said measured weather variables and combines said persistence prediction with said short term weather variables corrected as a function of said time function error model to output said corrected short term predicted weather variables associated with said short term weather predicted variables.

11. A short term weather forecaster as claimed in claim 2, wherein said error correction unit generates a persistence prediction of short term precipitation based on persistence of said measured precipitation variables and combines said persistence prediction with said short term precipitation variables corrected as a function of said time function error model to output said corrected short term predicted precipitation variables associated with said short term predicted precipitation variables.

12. A short term weather forecaster as claimed in claim 1, wherein said short term forecasting is less than twelve hours.

13. A numerical weather predictor (NWP) for forecasting comprising:
a numerical weather prediction module receiving measured weather variables and generating, as a function of a first mathematical model and of said measured weather variables, short term and long term predicted weather variables;
an error modeling unit receiving said short term predicted weather variables and corresponding measured weather variables, and generates an error model based on short term past predicted and measured weather variables;
wherein said numerical weather prediction module uses said error model to estimate adjusted initial conditions of said first mathematical model.

14. A short term weather forecaster as claimed in claim 13, wherein said numerical prediction module uses said error model to generate short term corrected predicted weather variables, said corrected predicted weather variables being used to estimate said adjusted initial conditions of said first mathematical model.

15. A short term weather forecaster as claimed in claim 14, wherein said measured weather variables and said predicted weather variables comprise precipitation variables representing precipitation maps, and said error model corrects errors in said precipitation maps.

16. A short term weather forecaster as claimed in claim 13, wherein said measured weather variables and said predicted weather variables comprise precipitation variables representing precipitation maps, and said error model corrects errors in said precipitation maps.
